(19) United States
(12) Patent Application Publication
(10) Pub. No.: US 2025/0157355 A1
(43) Pub. Date: May 15, 2025

(54) LEARNING SUPPORT SYSTEM

(71) Applicant: UMELABO CO., LTD., Osaka-shi, Osaka (JP)

(72) Inventor: Yusuke UMEZAKI, Osaka-shi, Osaka (JP)

(21) Appl. No.: 18/840,073

(22) PCT Filed: Oct. 31, 2023
(86) PCT No.: PCT/JP2023/039212

§ 371 Date: Aug. 21, 2024

(30) Foreign Application Priority Data
Nov. 11, 2022 (JP) 2022-180855

(51) Int. Cl. G09B 7/04

(52) U.S. Cl. CPC G09B 7/04

(57) ABSTRACT

To provide a learning support system that enables efficient lifelong learning. A learning support system 10 includes a question storage unit 12 in which a plurality of questions for a learner 4 to acquire knowledge and answers respectively corresponding to the plurality of questions are registered, a question interval determination unit 14 configured to determine, in determining a date and time for submitting each of the plurality of questions, a question interval such that an effect of learning by the learner 4 is enhanced, a question frequency adjustment unit 16 configured to multiply the question interval of a question of low learning need for the learner 4 by a predetermined multiplying factor that reduces a frequency of the question of low need, and a question submission unit 18 configured to submit each of the questions to the learner 4, on the basis of the question interval determined by the question interval determination unit 14 and the question interval having been adjusted by the question frequency adjustment unit 16.

### TECHNICAL FIELD

The present invention relates to learning support systems.

### BACKGROUND OF THE INVENTION

Traditionally, learners learned through paper-based media, but with the developments in digital technology, software and other means for learning have been developed. As technology related to the present invention, for example, Patent Document 1 describes a learning support device for generating learning questions that promote learner's motivation for learning, comprising: a learning content acquisition means for acquiring learning contents that represent the contents of learning questions; an exercise theme acquisition means for acquiring exercise themes applicable to the learning questions; a learning question generation means for dynamically generating learning questions by combining the learning contents and the question themes; and a question submission means for submitting to the learner one or more of the generated learning questions as a series of questions.

### PRIOR ART

### Patent Documents

Patent Document 1: JP 2017-068189 A

### SUMMARY OF THE INVENTION

### Problem to be Solved by the Invention

In recent years, an increasing number of people have been engaging in lifelong learning. For example, a single learner may attempt various qualification examinations, etc. As the number of subjects to be studied increases, as in the case of various qualification exams, etc., the number of daily quotas increases, making it easier to set back. Furthermore, repeatedly learning what has already been fully established in memories reduces time devoted to questions to be studied, resulting in the issue of inefficiency in learning.

An objective of the present invention is to provide a learning support system that enables efficient lifelong learning.

### Means for Solving the Problems

A learning support system involving the present invention includes a question storage unit in which a plurality of questions for a learner to acquire knowledge and answers respectively corresponding to the plurality of questions are registered, a question interval determination unit configured to determine, in determining a date and time for submitting each of the plurality of questions, a question interval such that an effect of learning by the learner is enhanced, a question frequency adjustment unit configured to multiply the question interval of a question of low learning need for the learner by a predetermined multiplying factor that reduces a frequency of the question of low need, and a question submission unit configured to submit each of the questions to the learner, based on the question interval determined by the question interval determination unit and the question interval having been adjusted by the question frequency adjustment unit. The plurality of questions are classifiable by a plurality of subjects. The question frequency adjustment unit is configured to set the predetermined multiplying factor on a per-subject basis.

With the learning support system involving the present invention, it is preferable that the plurality of questions be classifiable by the plurality of subjects, and that the learning support system further comprise a subject extension setting unit that adds a predetermined period to the question interval on a per-subject basis.

Also with the learning support system involving the present invention, it is preferable that the question submission unit select a plurality of questions from among questions a next scheduled submission date of which is within a given period, and submit the selected questions earlier than scheduled.

### Effects of the Invention

According to the present invention, efficient lifelong learning may be made available.

### BRIEF DESCRIPTION OF DRAWINGS

FIG. 1 is a diagram illustrating a learning support system of an embodiment involving the present invention.

FIG. 2 is a diagram illustrating a situation in which a question has been submitted using the learning support system of the embodiment involving the present invention.

FIG. 3 is a diagram illustrating a situation in which the question submitted using the learning support system of the embodiment involving the present invention has been answered.

FIG. 4 is a diagram illustrating a situation in which the learning support system of the embodiment involving the present invention is used to register a question.

FIG. 5 is a diagram illustrating a situation in which the question registered using the learning support system of the embodiment involving the present invention has been submitted.

FIG. 6 is a diagram illustrating a situation in which the question submitted using the learning support system of the embodiment involving the present invention has been answered.

FIG. 7 is a diagram illustrating a situation in which the learning support system of the embodiment involving the present invention is used to set a multiplying factor, etc.

### DETAILED DESCRIPTION OF THE INVENTION

Hereinafter, a mode of embodying the present invention is explained in detail with reference to the accompanying drawings. In the following, like elements are assigned the same reference numerals in all the figures in the drawings, and a repeated description is omitted. In addition, in the description in the text, the reference numerals mentioned previously are used if necessary.

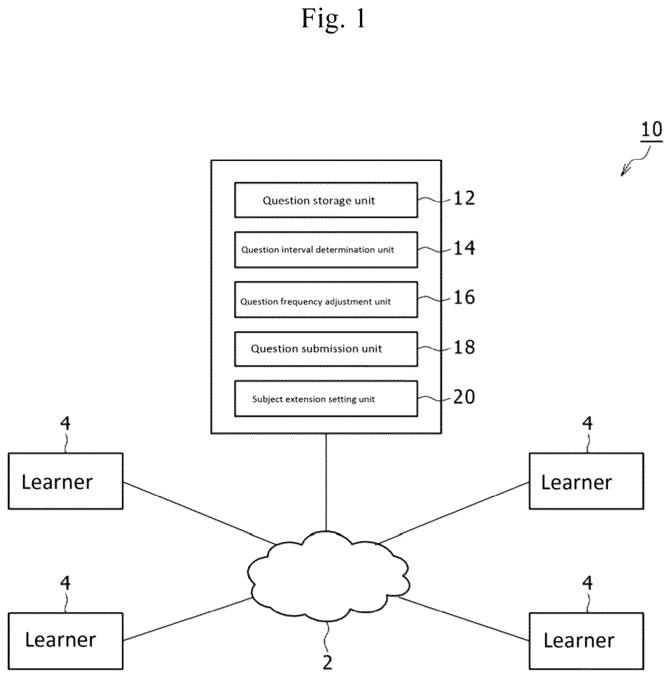

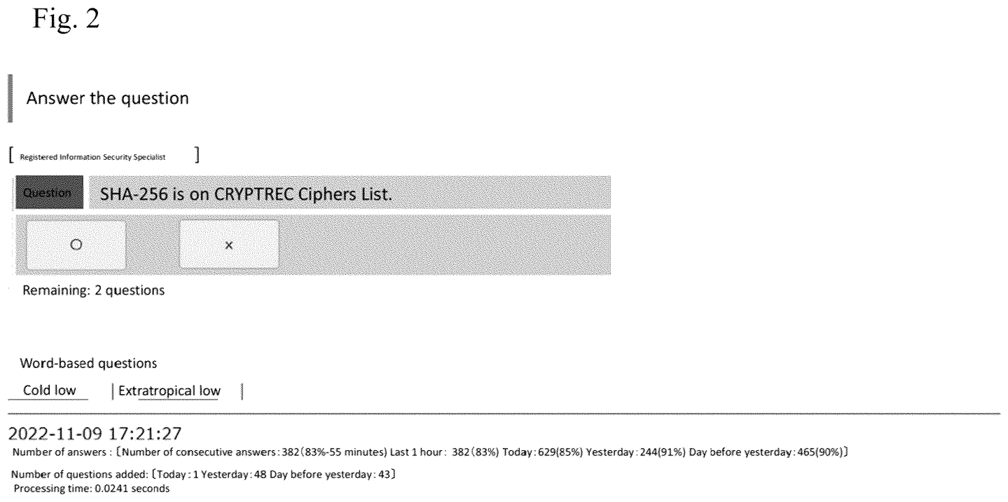

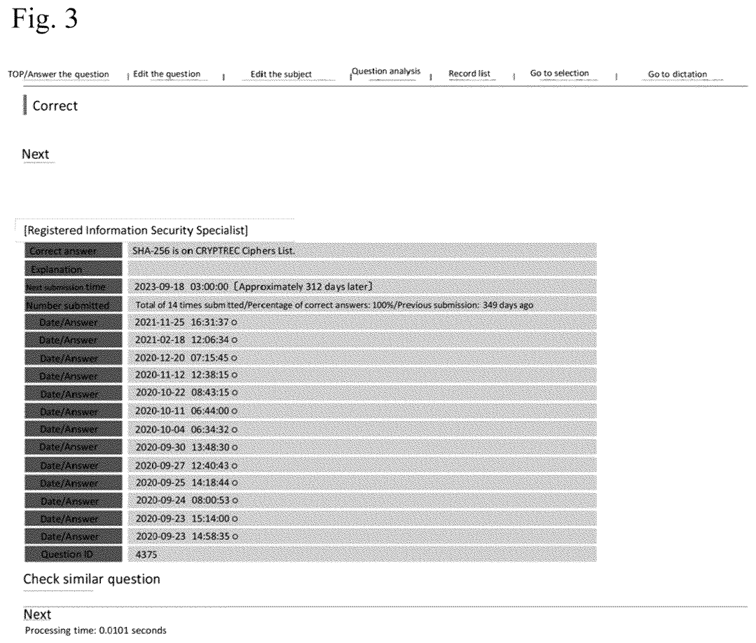

FIG. 1 is a diagram illustrating a learning support system 10 of an embodiment involving the present invention. FIG. 2 is a diagram illustrating a situation in which a question has been submitted using the learning support system 10 of the embodiment involving the present invention. FIG. 3 is a diagram illustrating a situation in which the question submitted using the learning support system 10 of the embodiment involving the present invention has been answered.

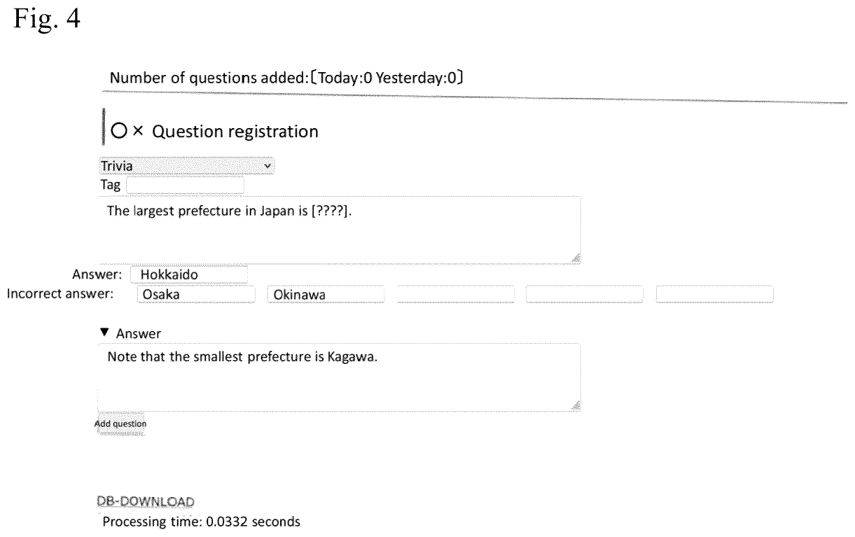

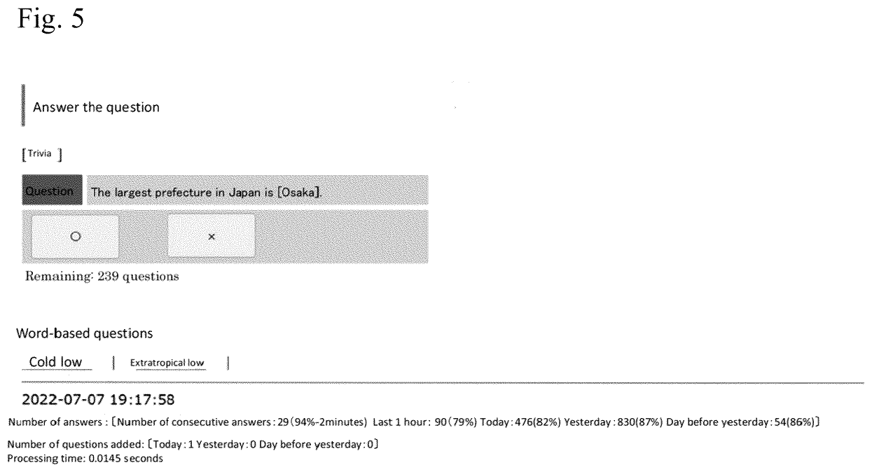

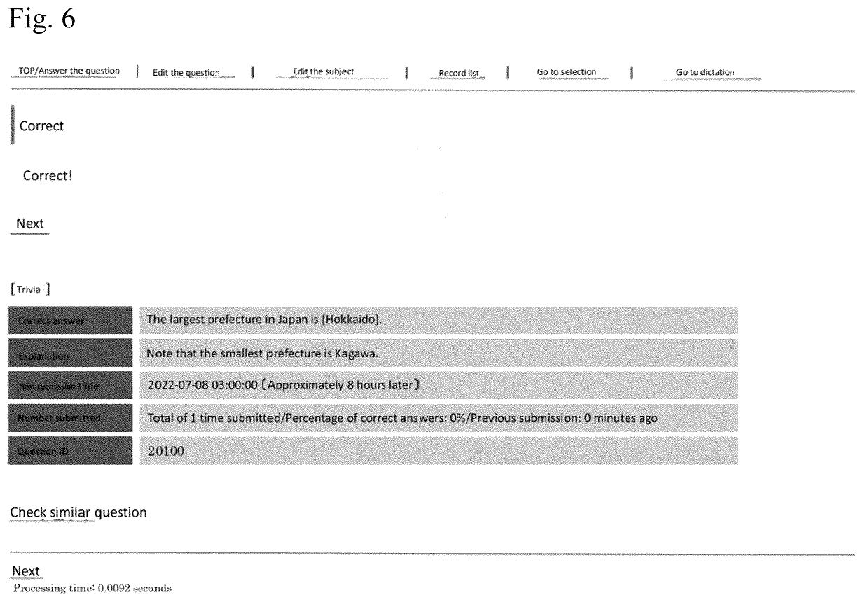

FIG. 4 is a diagram illustrating a situation in which the learning support system 10 of the embodiment involving the present invention is used to register a question. FIG. 5 is a diagram illustrating a situation in which the question registered using the learning support system 10 of the embodiment involving the present invention has been submitted. FIG. 6 is a diagram illustrating a situation in which the question submitted using the learning support system 10 of the embodiment involving the present invention has been answered.

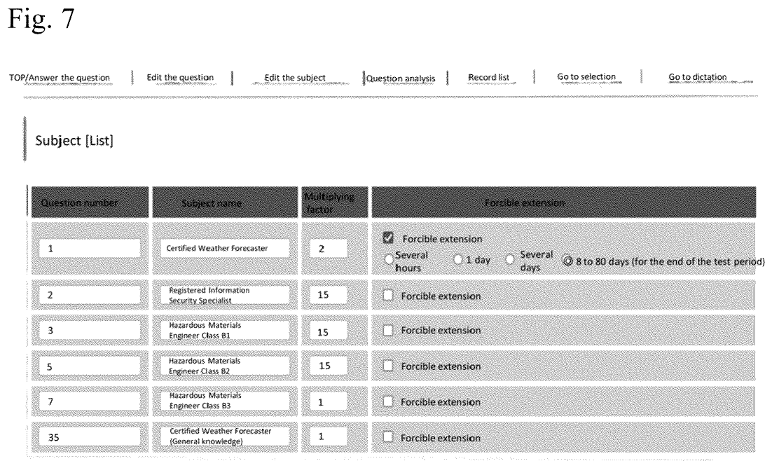

FIG. 7 is a diagram illustrating a situation in which the learning support system 10 of the embodiment involving the present invention is used to set a multiplying factor, etc.

The learning support system 10 is a system to help a learner 4 learn efficiently for lifelong learning. The learning support system 10 includes a question storage unit 12, a question interval determination unit 14, a question frequency adjustment unit 16, a question submission unit 18, and a subject extension setting unit 20.

The question storage unit 12 has a function for registering a plurality of questions for the learner 4 to acquire knowledge and answers respectively corresponding to the plurality of questions. Here, as illustrated in FIG. 4, description is given of an instance in which the learner 4 himself/herself can create and register questions that he/she wish to study, but questions prepared in advance may also registered.

In the example shown in FIGS. 4 and 5, the question “Osaka is the prefecture having the largest area in Japan” is to be answered with ◯ and x. Here, if x is selected, “correct” is displayed, as illustrated in FIG. 6. Naturally, since the correct answer to this question is “Hokkaido,” the correct answer is displayed and, as related information, the fact that the prefecture having the smallest area is “Kagawa” is also displayed.

Questions registered by the question storage section 12 is classified into a plurality of subjects. The subjects may be classified as, for example, Japanese history, world history, English, mathematics, chemistry, physics, biology, etc., as well as by qualifications such as Certified Weather Forecasters, Registered Information Security Specialist, Real Estate Notary, Patent Attorney, Certified Administrative Procedures Legal Specialist, etc.

In determining a date and time for submitting each of the plurality of questions, the question interval determination unit 14 has a function of determining a question interval so as to enhance the learning effect of the learner 4 on the basis of the Ebbinghaus' forgetting curve. The Ebbinghaus' forgetting curve is a graph that plainly represents the mechanism through which people forget, with “savings” on the vertical axis and “time” on the horizontal axis.

On the basis of the Ebbinghaus' forgetting curve, the question interval determination unit 14 can set an interval so that learnt contents are efficiently retained. For example, the interval can be set as follows: 10 minutes, until 3:00 the next morning, 5 to 6 days, 10 to 14 days, 15 to 20 days, and 21 to 28 days after learning. While the interval is set in this way, if the learner makes a mistake on a question, the frequency of the question returns to the beginning, that is, the question is submitted 10 minutes later, at 3:00 the next morning, and so on.

The question interval determination unit 14 can set a question interval to 34-39 days, 40-50 days, 51-79 days, 80-90 days when the percentage of correct answers remains 70% or above, and thereafter, when the percentage of correct answers is above 90%, can set a question interval, for example, by using the following formula: 86400 seconds×(random number (75-90)+ (number of correct answers×3)).

The question frequency adjustment unit 16 multiplies the question interval for questions of low learning need for the learner 4 by a predetermined multiplying factor so as to reduce the frequency of the questions of low need. The predetermined multiplying factor here is described as being set on a per-subject basis, but it may also be set on a per-question basis.

For example, a person who has passed the qualification examination for Registered Information Security Specialist has already acquired the knowledge for this qualification examination, so there is little need to re-solve the questions frequently, and it would be more efficient to spend the time for other studies.

However, if he/she stops studying at all, there is a possibility that his/her knowledge will be lost. Therefore, for example, as illustrated in FIG. 7, the question interval for questions for Registered Information Security Specialist is multiplied by a predetermined multiplying factor (e.g., 15 times) to increase the interval. In this way, the question frequency adjustment unit 16 allows for setting of the predetermined multiplying factor on a per-subject (e.g., Registered Information Security Specialist) basis.

Specifically, multiplying the period of the question interval by the predetermined multiplying factor allows for adjustment such that, for example, a question originally to be submitted in 30 days will be submitted in one year. This has the advantage that questions registered several years ago will be submitted at a time when the learner has almost forgotten about them, and thereby the memory retention is improved.

For example, if the number of seconds until the question is submitted is 2,937,600 seconds (34 days) and the multiplying factor is 15, the question can be adjusted so that it is not submitted for 2,937,600 seconds×15=44,064,000 seconds (510 days), i.e., more than one year.

The advantage is that while spending time on questions of high need, the learner can also learn questions of low need at a reduced frequency as described above so that the knowledge is not lost, which serves lifelong learning.

As the number of registered questions increases, a large number of questions may be submitted in a day, which may discourage learner 4 from learning. However, by making adjustment as described above, it is possible to distribute submission of the registered questions and keep the motivation for learning of the learner 4.

The question frequency adjustment unit 16 has an additional function of adding 5 to 7 days to the question interval when the number of correct answers is 12 or more. This is because it is judged that frequent submission of questions that have been answered correctly 12 or more times in the past will not affect learning.

Furthermore, the question frequency adjustment unit 16 has an additional function of adding 1 to 2 days to the question interval if the number of correct answers is less than 12 but the multiplying factor is 2 or greater. This is because it is judged that even if the number of correct answers is less than 12, when the multiplying factor is 2 or greater, there is little need to rush to re-submit the question.

The question frequency adjustment unit 16 has an additional function to provide a time difference of about 5 hours for each question if the next submission is due in 24 hours or later. This process ensures that the questions are not concentrated at a specific time, but are distributed.

The question frequency adjustment unit 16 has an additional function to set the date and time of the next submission to 300-360 days, up to 360 days, if the number of correct answers is 16 or less. Multiplication by a multiplying factor as described above may result in an extremely long question interval, such as 510 days before submission. The reason for this is to ensure that adjustments are made such that questions are always submitted at least once a year, because questions that are registered near the end of the qualification examinations, the examination for which is held immediately after, and the multiplying factor for which is set high may be particularly subject to an extreme drop in the number submitted.

Furthermore, the question frequency adjustment unit 16 sets the interval to 1820 days as the upper limit, if the number of correct answers exceeds 16 times and the interval is 1820 days or more. This is because even if the number of correct answers is many, without the upper limit of 1820 days (5 years), there is a possibility that the memory cannot be maintained.

The question frequency adjustment unit 16 has an additional function to add 6 to 7 days if the next submission is due in 3 days or later and between December 31 and January 4. This process is based on the assumption that the learner 4 may wish to take a break during the year-end and New Year holidays. It should be noted that with the limitation of 3 days or later, it does not mean that the question will not be submitted at all.

The question frequency adjustment unit 16 has an additional function to add 2 to 5 days if the next submission is due in 8 days or more and on a Saturday or Sunday. The reason for this process is based on an assumption that the learner 4 may wish to take a break on Saturdays and Sundays.

Furthermore, the question frequency adjustment unit 16 has an additional function to add or subtract 1 day if the next submission is due in 20 days or later and on a Wednesday. This is based on an assumption that slightly reducing the frequency of the questions on Wednesdays may help the learner 4 maintain his/her motivation to study.

The question frequency adjustment unit 16 has an additional function to standardize the time of the submission at, for example, 3:00 a.m., if the next submission is due in 3 days or later. This is to prevent learner 4 from feeling stressed when the number of questions exceeds 100, and even after all the questions have been answered correctly, different questions are submitted soon afterwards.

On the basis of the question intervals determined by the question interval determination unit 14 and the questioning intervals having been adjusted by the question frequency adjustment unit 16, the question submission unit 18 submits each question to the learner 4.

Specifically, after the learner 4 registers a question that he/she wishes to learn as illustrated in FIG. 4, the question will be submitted to a terminal (smartphone, tablet device, or personal computer) of the learner 4 at intervals such as 10 minutes, until 3:00 the next morning, 5 to 6 days, 10 to 14 days, 15 to 20 days, and 21 to 28 days.

The question submission unit 18 has an additional function to select a plurality of questions from among the questions the next scheduled submission date of which is within a given period, and submit them earlier than scheduled. Specifically, from among the questions the next submission date of which is scheduled, for example, within 20 days, a question with which “a certain period of time has passed since the previous submission date and the next submission is due in the nearest future” is submitted earlier than scheduled.

The questions to be submitted earlier than scheduled, for example, are those that are scheduled to be submitted within 24 hours when the day on which the questions were previously answered was 5 days ago. In order that questions be submitted earlier from as wide a range of subjects as possible, as a general rule, no more than 4 questions should be submitted from each subject, but if there are no available questions, the search is made not on a per-subject basis but from among all genres, so the number of questions is not necessarily limited to 4.

The subject extension setting unit 20 has a function to add a predetermined period on a per-subject basis to a question interval. As illustrated in FIG. 7, the subject extension setting unit 20 has, as the time to be forcibly extended, options such as a few hours, 1 day, a few days, and 8 to 80 days, and adds the selected extension period to the question interval.

For example, extension of time is available for 1 day when the learner decides that he/she is busy today, for a few days when he/she feels like taking a few days off, or for 8 to 80 days when he/she decides that there is little need to study because there are no exams for a while.

The operability of the learning support system 10 in the above configuration will now be explained. The learner 4 creates questions related to the learning contents that he/she himself/herself intends to study, and as illustrated in FIG. 4, registers the questions himself/herself.

After registration by the learner 4 himself/herself, the question will be submitted to a terminal (smartphone, tablet device, or personal computer) of the learner 4 at intervals such as 10 minutes, until 3:00 the next morning, 5 to 6 days, 10 to 14 days, 15 to 20 days, and 21 to 28 days.

The above intervals are set so that the memory retention of the learnt contents is appropriate on the basis of the Ebbinghaus' forgetting curve, enabling the learner 4 to learn efficiently.

However, as the number of questions the learner 4 has registered increases, the number of questions submitted in a day also increases, by which the learner 4 may be discouraged from learning, resulting in decrease in learning efficiency. For example, a person who has passed the qualification examination for Registered Information Security Specialist has already acquired the knowledge for this qualification examination, so there is little need to re-solve the questions frequently, and it would be more efficient to spend the time for other studies.

However, if he/she stops studying at all, there is a possibility that his/her knowledge will be lost. Therefore, for example, as illustrated in FIG. 7, the question interval for questions for Registered Information Security Specialist is multiplied by a predetermined multiplying factor (e.g., 15 times) to increase the interval. In this way, the question frequency adjustment unit 16 allows for setting of the predetermined multiplying factor on a per-subject (e.g., Registered Information Security Specialist) basis. This has the advantage that questions registered several years ago will be submitted at a time when the learner has almost forgotten about them, and thereby the memory retention is improved.

With the learning support system 10, the advantage is that while spending time on questions of high need, the learner can also learn questions of low need at a reduced frequency as described above so that the knowledge is not lost, which serves lifelong learning.

Also with the learning support system 10, extension of time is available for 1 day when the learner decides that he/she is busy today, for a few days when he/she feels like taking a few days off, or for 8 to 80 days when he/she decides that there is little need to study because there are no exams for a while, so that the learner can continue studying within a reasonable range. Therefore, the system is suitable for lifelong learning.

### LIST OF REFERENCE NUMERALS

4: Learner, 10: Learning support system, 12: Question storage unit, 14: Question interval determination unit, 16: Question frequency adjustment unit, 18: Question submission unit, 20: Subject extension setting unit

1. A learning support system comprising:
a question storage unit in which a plurality of questions for a learner to acquire knowledge and answers respectively corresponding to the plurality of questions are registered;
a question interval determination unit configured to determine, in determining a date and time for submitting each of the plurality of questions, a question interval such that an effect of learning by the learner is enhanced;
a question frequency adjustment unit configured to multiply the question interval of a question of low learning need for the learner by a predetermined multiplying factor that reduces a frequency of the question of low need; and
a question submission unit configured to submit each of the questions to the learner, based on the question interval determined by the question interval determination unit and the question interval having been adjusted by the question frequency adjustment unit;
the plurality of questions being classifiable by a plurality of subjects,
the question frequency adjustment unit being configured to set the predetermined multiplying factor on a per-subject basis.

2. The learning support system according to claim 1, wherein
the plurality of questions are classifiable by the plurality of subject,
the learning support system further comprising a subject extension setting unit configured to add a predetermined period to the question interval on the per-subject basis.

3. The learning support system according to claim 1, wherein
the question submission unit is configured to select a plurality of questions from among questions a next scheduled submission date of which is within a given period, and submit the selected questions earlier than scheduled.
